(19) United States
(12) Patent Application Publication
(10) Pub. No.: US 2025/0374874 A1
(43) Pub. Date: Dec. 11, 2025

(54) IRRIGATION SYSTEM HAVING FLEXIBLE JOINTS AND IMPROVED END SEGMENTS FOR REDUCING WATER DISTRIBUTION DEAD ZONES

(71) Applicant: Reinke Manufacturing Company, Inc., Deshler, NE (US)

(72) Inventors: Russell Scott REINKE, Deshler, NE (US); Jon Patrick HENRY, Deshler, NE (US); Brennan Joos ZIEGELMEIER, Colby, KS (US); Darin Joseph NEFF, Hebron, NE (US); Mark Randall VIRUS, Hebron, NE (US)

(21) Appl. No.: 19/037,979

(22) Filed: Jan. 27, 2025

Related U.S. Application Data
(63) Continuation-in-part of application No. 17/976,232, filed on Oct. 28, 2022, now Pat. No. 12,209,696.
(63) Continuation-in-part of application No. 18/771,847, filed on Jul. 12, 2024.

(51) Int. Cl. A01G 25/09

(52) U.S. Cl. CPC A01G 25/092

(57) ABSTRACT

An irrigation system having spans of a variable overall length is provided. Each span has a plurality of fluid delivery conduits coupled end to end to define the span with a first peripheral end and a second peripheral end. Each fluid delivery conduit has a plurality of receptacles uniformly spaced along its length. The first peripheral end has a first end segment and the second peripheral end has a second end segment. The lengths of the first and second end segments are less than half of the uniform distance by which each of the plurality of receptacles is spaced apart. Uniform spacing of receptacles is maintained across a connection of adjacent spans.

### CROSS REFERENCE TO RELATED APPLICATIONS

This application is a continuation-in-part of U.S. application Ser. No. 17/976,232 (filed Oct. 28, 2022) and is a continuation-in-part of U.S. application Ser. No. 18/771,847 (filed Jul. 12, 2024), each of which is incorporated herein by reference in its entirety.

### TECHNICAL FIELD

Aspects provided relate to irrigation systems. More specifically, aspects provided relate to an improved irrigation system for agricultural settings where the end segments of each span are designed to reduce the water distribution dead zones when connecting multiple spans together.

### BACKGROUND

Agricultural irrigation systems generally include a pipeline adapted to communicate fluid from a fluid source to a field. The pipeline is typically supported above the field by one or more towers and a trussing system. In large fields, the pipeline includes multiple spans connected to one another to cover the full area of the field.

However, in doing so, the end segments of each span in prior art irrigation systems produce locations in which water distribution receptacles are not uniformly spaced along the full length of the pipeline. The result of not having uniformly spaced receptacles means that there are water distribution “dead zones”, where certain segments of the field do not receive proper irrigation. It is thus the aim of this invention to provide spans having improved end segments that eliminate or significantly reduce water distribution “dead zones”, such that fields receive uniform water distribution.

In addition, in some instances, connections along the pipeline are inflexible in one or more respects and/or are susceptible to pre-mature wear.

### SUMMARY

The present disclosure generally relates to irrigation systems for use in agricultural settings. At a high level, aspects herein are directed an irrigation system having a variable overall length by way of coupling together multiple spans, or by varying the length of the pipes used within each span. Each span comprises a plurality of fluid delivery conduits having a plurality of receptacles spaced along a length of the plurality of fluid delivery conduits, wherein the plurality of fluid delivery conduits comprises a first peripheral end and a second peripheral end, a first end segment coupled to the first peripheral end and a second end segment coupled to the second peripheral end, each of the first end segment and the second end segment having a length that is shorter than the length of the plurality of fluid delivery conduits. The irrigation system also comprises a trussing system coupled to the first peripheral end and the second peripheral end of the plurality of fluid delivery conduits, wherein the trussing system comprises a plurality of support structures coupled to the plurality of fluid delivery conduits, wherein each of the plurality of receptacles is spaced apart by a uniform distance, wherein the length of the first end segment and the length of the second end segment is less than half of the uniform distance by which each of the plurality of receptacles is spaced apart.

In another example, aspects herein are directed to an array of spans coupled together to form an irrigation system. The array of spans comprises at least a first span and a second span, each of the first span and the second span comprising a plurality of fluid delivery conduits having a plurality of receptacles spaced along the plurality of fluid delivery conduits, wherein the plurality of fluid delivery conduits comprises a first peripheral end and a second peripheral end. Each span comprises a first end segment coupled to the first peripheral end and a second end segment coupled to the second peripheral end, each of the first end segment and the second end segment having a length that is shorter than the length of the plurality of fluid delivery conduits, and a trussing system coupled to the first peripheral end and the second peripheral end of the plurality of fluid delivery conduits, wherein the trussing system comprises a plurality of support structures coupled to the plurality of fluid delivery conduits, wherein each of the plurality of receptacles is spaced apart by a uniform distance, and wherein the length of the first end segment and the length of the second end segment is less than half of the uniform distance by which each of the plurality of receptacles is spaced apart. Finally, when the first span and the second span are coupled together, the second end segment of the first span and the first end segment of the second span are coupled together, such that the uniform distance between the plurality of receptacles is maintained across the connection between the first span to the second span.

In another example, the present disclosure is related to a pipe joint or span coupling which can connect a span of an irrigation system to another structure and can enable the span to more efficiently rotate or pivot in one or more axes of motion with reduced part wear. In examples, the joint can include various components that attach an end of a first pipe or joint to an end of a second pipe or joint. For example, the end of the first joint can include a receiver plate, which can include a recess with a bushing. In addition, the end of the second joint can include a post, hook, or other elongated member that, in order to connect the first joint to the second joint, is insertable into the bushing. In examples, based on the elongated member (e.g., post, hook, or other) being inserted into the recess and bushing, the first joint and/or the second joint can rotate relative to one another. Furthermore, based at least in part on the bushing, relative movement between the joints can be efficient and associated with reduced part wear or reduced damage (e.g., of the recess and the elongated member) and a precision alignment connection can be achieved between joint members.

### BRIEF DESCRIPTION OF THE SEVERAL VIEWS OF THE DRAWINGS

Illustrative embodiments of the present invention are described in detail below with reference to the attached drawing figures, which are incorporated by reference herein and wherein:

FIG. 1 depicts a side elevation view of a section or initial span of an irrigation system, in accordance with aspects hereof;

FIG. 2 is a top plan view of the irrigation system of FIG. 1;

FIG. 3 is a fragmentary side elevation view of a receptacle portion of the irrigation system of FIG. 1;

FIG. 4 is a fragmentary top plan view of a receptacle portion of the irrigation system of FIG. 2;

FIG. 5 is a schematic side elevation view of a variable length span of an irrigation system having a plurality of receptacles, in accordance with aspects hereof;

FIG. 6 is a schematic side elevation view of a variable length span of an irrigation system having uniformly spaced receptacle portions and uniform pipe lengths, in accordance with aspects hereof;

FIG. 7A is a fragmentary side elevation view of a connection of a pair of coupled end portions of adjacent spans, in accordance with aspects herein;

FIG. 7B is a fragmentary side elevation view of a connection of a pair of coupled end portions of adjacent spans, in accordance with the prior art;

FIG. 8 is a side elevation view of two spans constructed in accordance with aspects of the present invention coupled together;

FIG. 9A depicts a schematic top plan environmental view of and irrigation system with prior art spans operating in a field;

FIG. 9B depicts a schematic top plan environmental view of and irrigation system with spans implementing the present invention operating in a field;

FIG. 10 is an alternate schematic side elevation view of a variable length span of an irrigation system having uniformly spaced receptacle portions and uniform pipe lengths, in accordance with aspects hereof; and

FIG. 11 is another alternate schematic side elevation view of a variable length span of an irrigation system having uniformly spaced receptacle portions and uniform pipe lengths, in accordance with aspects hereof.

FIGS. 12A and 12B depict a span coupling of an irrigation system, in accordance

with examples of this disclosure.

FIGS. 13A, 13B, and 13C depict degrees of motion, including roll, yaw, and pitch, that can occur at a joint of an irrigation system, in accordance with examples of this disclosure.

FIG. 14 depicts a disassembled view of at least a portion of a span coupling of an irrigation system, including a bushing, in accordance with examples of this disclosure.

FIGS. 15A, 15B, and 15C depict various views of a bushing, in accordance with examples of this disclosure.

FIGS. 16A, 16B, and 16C depict cross-sectional views of a portion of a hook and a bushing, including interactions and movements therebetween, in accordance with examples of this disclosure.

FIGS. 17A, 17B, and 17C depict cross-sectional views of a portion of a hook and a bushing, including interactions and movements therebetween, in accordance with examples of this disclosure.

FIG. 18 depicts a receiver assembly of a joint, in accordance with examples of this disclosure.

FIG. 19 depicts a receiver plate in accordance with examples of this disclosure.

### DETAILED DESCRIPTION

The subject matter of the present invention is described with specificity herein to meet statutory requirements. However, the description itself is not intended to limit the scope of this disclosure. Rather, the inventors have contemplated that the claimed or disclosed subject matter might also be embodied in other ways, to include different steps or combinations of steps similar to the ones described in this document, in conjunction with other present or future technologies. Moreover, although the terms “step” and/or “block” might be used herein to connote different elements of methods employed, the terms should not be interpreted as implying any particular order among or between various steps herein disclosed unless and except when the order of individual steps is explicitly stated.

Aspects hereof may be described using relative location terminology. For example, the term “proximate” is intended to mean on, about, near, by, next to, at, and the like. The term “about” when used in relation to measurements means within ±10% of a designated value. Therefore, when a feature is proximate another feature, it is close in proximity but not necessarily exactly at the described location or in abutting contact, in some aspects. Additionally, the term “distal” refers to a portion of a feature herein that is positioned away from a midpoint of the feature. Terms such as “coupled,” “attached,” “fastened,” “secured,” “affixed,” and the like may mean elements that are releasably attached or connected to one another using, for example, bolts and the like. These terms may further mean elements that are permanently attached to one another using, for example, rivets, welding, and the like.

The term “releasable fastener” as used herein refers to a fastener system that can be repeatedly, selectively, coupled and uncoupled to respectively secure or disengage components from each other. In line with this, the term “complementary” when describing components of a releasable fastener system means components having structures that mechanically engage with each other (e.g., a nut and a bolt may mechanically engage one another at threads formed thereon).

The term “end” when used in relation to the end of a pipeline, rail, or trussing rod may mean a terminal edge of said component. Such term may also mean a portion of the pipeline, rail, or trussing rod within about 12 inches of the terminal edge of said component. The terms “axial direction” and “longitudinal direction” are used interchangeably herein and mean the direction the pipeline, rail, or trussing rod extends from a first end of said component to a second end of said component. The term “substantially” when used in relation to positional descriptions means primarily.

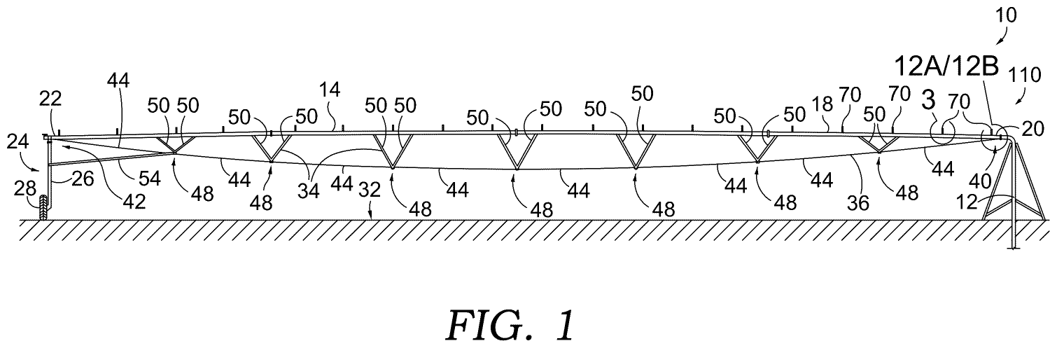

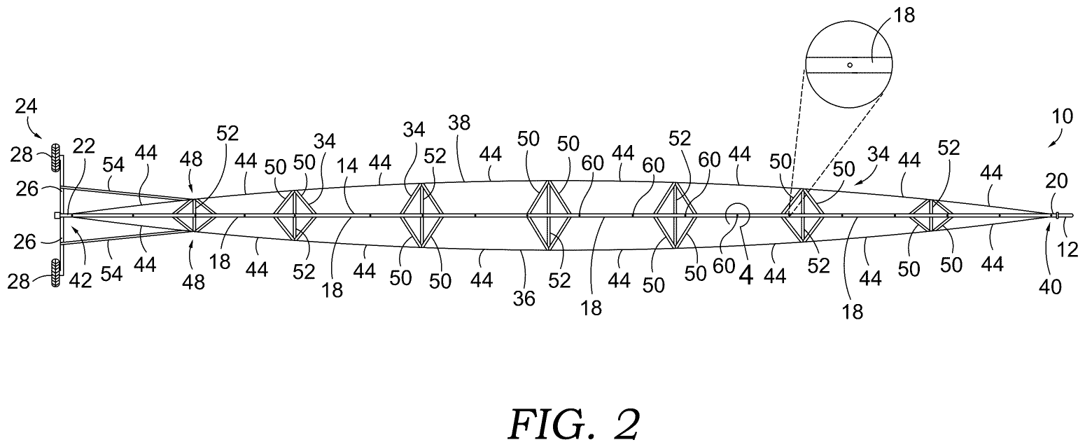

Referring now initially to FIG. 1, a side or elevation view of an irrigation system 10 of the present invention is illustrated. In FIG. 2, a top plan view of the irrigation system 10 of FIG. 1 is illustrated. The illustrated irrigation system 10 is a center-pivot type irrigation system that revolves or rotates around a fluid source 12. In other aspects, however, the irrigation system may be a linear or lateral move irrigation system, or any other type of irrigation system. The irrigation system 10 includes a plurality of fluid delivery pipes or conduits 14 coupled together and, ultimately, to the fluid source 12. The plurality of fluid delivery conduits 14 extend from the fluid source 12 to a mobile tower 24, thereby representing an initial or first span of the irrigation system 10. As discussed in more detail below, multiple spans may be coupled together to expand the coverage area of the irrigation system 10.

When coupled together, the plurality of fluid delivery conduits 14 generally form a continuous pathway for fluid to flow through. In other words, the plurality of fluid delivery conduits 14 are coupled together to form a single piping structure for fluid to flow within. However, in other aspects, the plurality of fluid delivery conduits 14 may comprise a single pipe segment. When discussing the plurality of fluid delivery conduits 14 herein, discussions may be related the plurality of fluid delivery conduits 14 in a disassembled form (i.e. each conduit separately), or discussions may be related to the plurality of fluid delivery conduits 14 in an assembled form (as illustrated in FIGS. 1 and 2).

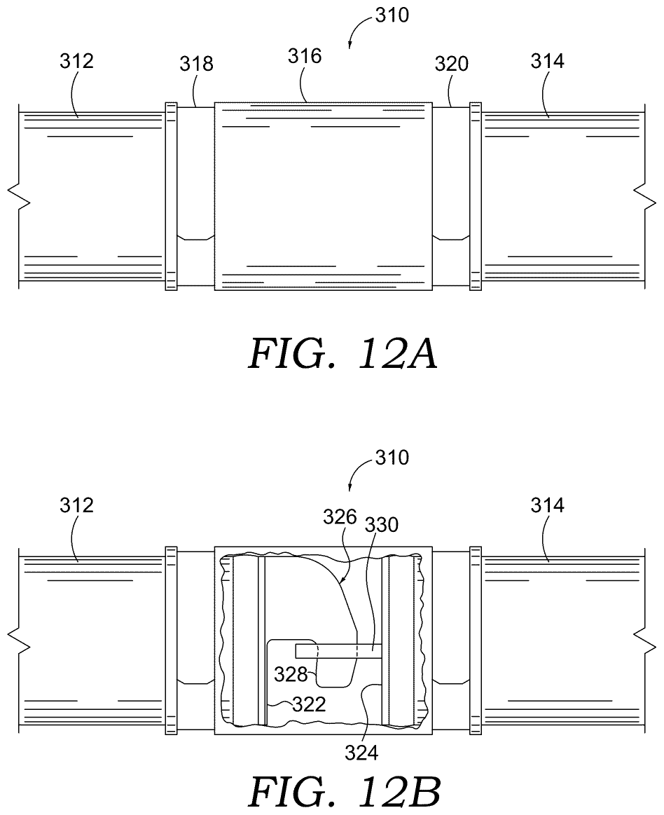

A first end segment 20 of the plurality of fluid delivery conduits 14 may connect to the fluid source 12 with a span coupling 110. The first end segment 20 may include the span coupling, or a portion of the span coupling (e.g., a hook or a receiver plate), for detachably coupling to the fluid source 12. The span coupling may comprise a hook and receiver type span coupling. For example, the first end segment 20 may include a hook that may be detachably coupled to a receiver (e.g., a ring or plate with a recess) connected to the fluid source 12. Such a span coupling may provide a highly efficient point of rotation for the plurality of fluid delivery conduits 14 when placed in the center of the plurality of fluid delivery conduits 14. Examples of span couplings are described in further detail with respect to FIGS. 12A through 19, any of which could join the first end segment to the fluid source 12.

In the illustrated embodiment of a single span, the plurality of fluid delivery conduits 14 have a second end segment 22 at a distal end. Generally it is advantageous to provide a multi-span irrigation system to permit irrigation of a greater area. For example, the irrigation system 10 may comprise a first span, a second span, multiple additional spans, and may terminate in an ancillary span or a swing arm that is attached to the final span. Thus, a multi-span irrigation system may be composed of two or more spans which cooperate together to form a single length of the irrigation system 10. Accordingly, in embodiments, the second span, ancillary span, or swing arm may be coupled to the second end segment 22 of the plurality of fluid delivery conduits 14 of the irrigation system 10 to increase the area over which the irrigation system 10 travels. Thus, the second end segment 22 of the plurality of fluid delivery conduits 14 may include a span coupling (e.g., a hook and a receiver), or a portion of a span coupling, (e.g., a receiver) for connecting to a span coupling (e.g., a hook) of the second span, ancillary span, or swing arm. Hook-and-receiver type span couplings known in the art are preferred, but other types of span couplings may also be useful with the present invention. In at least some examples, any of the span couplings described with respect to FIGS. 12A through 19 can join spans, and can join the second end segment 22 to other structures (e.g., spans, towers, etc.).

The mobile tower 24 supports the second end segment 22 of any individual span. In other aspects, the mobile tower 24 may support an intermediate portion of multiple spans that have been coupled together resulting in a portion of the plurality of fluid delivery conduits 14 cantilevered past the mobile tower 24 (e.g., an ancillary span). The mobile tower 24 includes one or more support legs 26 and one or more wheels 28. In some aspects, the mobile tower 24 is self-propelled and includes a drive unit that causes the wheels to rotate to move the plurality of fluid delivery conduits 14 over a field 32. In other aspects, other equipment (e.g., electronics) may be mounted on the mobile tower 24.

A trussing system 34 includes a first truss rail 36 and a second truss rail 38 (best illustrated in FIG. 2). In some embodiments, the trussing system 34 may include only one truss rail. In other aspects, the trussing system 34 may include more than two trussing rails. The first truss rail 36 and the second truss rail 38 are substantially similar and the following description of the first truss rail 36 applies equally to the second trussing rail 38. A first end 40 of the first truss rail 36 is coupled to the first end segment 20 of the plurality of fluid delivery conduits 14. Likewise, a second end 42 of the first truss rail 36 is coupled to the second end segment 22 of the plurality of fluid delivery conduits 14. The first truss rail 36 and second truss rail 38 are generally formed by a plurality of rail segments or truss rods 44 connected together end to end.

The trussing system 34 also includes a plurality of pairs of struts 50 extending from the plurality of fluid delivery conduits 14 to which they are coupled via conventional means (e.g., fastened via bolts to a plate that is welded to the plurality of fluid delivery conduits 14). Each pair of struts 50 additionally is coupled to each other at one of the intermediate joints 48, as more fully described below. The trussing system 34 further includes a plurality of cross-members 52 (FIG. 2). Each said cross-member 52 extends from one of the intermediate joints 48 of the first truss rail 36 to an intermediate joint of the second truss rail 38 and spaces the intermediate joints, and thereby the first and second trussing rails 36, 38, apart. In the illustrated embodiment, a brace 54 also extends from the mobile tower 24 to one of the intermediate joints 48 (best seen in FIGS. 1 and 2) to provide additional support and to stabilize the mobile tower 24. In some aspects, one or more of the intermediate joints may comprise flying joints that do not have a strut 50, a cross-member 52, or a brace 54 attached.

In the illustrated irrigation system 10 depicted in FIGS. 1 and 2, the span further comprises a plurality of receptacles 60 spaced along the length of the fluid delivery conduits 14. In accordance with aspects herein, the plurality of receptacles 60 are generally known to be the female mating connection point for a water distribution mechanism, such as a sprinkler. In other words, the water distribution mechanism is commonly (but not always) a separate component, which needs to be coupled to the plurality of fluid delivery conduits 14. The location at which the coupling is done is generally at each of the plurality of receptacles 60 discussed herein, with the plurality of receptacles 60 playing the female role in the coupling process. In other words, the water distribution mechanism plays the male role when coupled to the plurality of receptacles 60. In FIGS. 1 and 2, the plurality of receptacles 60 are generally illustrated as radial, although other shapes are considered to be within the scope of this disclosure. For example, the plurality of receptacles 60 may be square, rectangular, circular, ovular, triangular, or any other standard geometric shape.

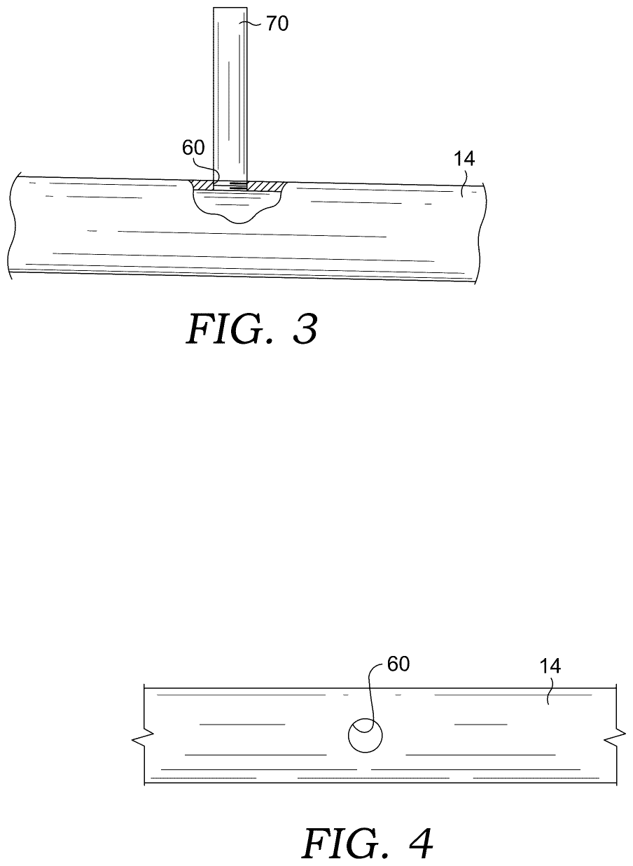

Turning now to FIGS. 3 and 4, a water distribution mechanism 70 is illustrated as coupled to one of the plurality of fluid delivery conduits 14 by way of the a receptacle 60. FIG. 3 depicts a side view of this structure and FIG. 4 depicts a top view of this structure. As discussed herein, the specific shape of the male and female connections is variable, with the shapes of round, radial, square, rectangular, circular, ovular, triangular, or any other standard geometric shape considered to be within the scope of this disclosure. Furthermore, the water distribution mechanism 70 may be a sprinkler, although other types of water distribution mechanisms (such as a fountain) are also considered to be within the scope of this disclosure.

Generally, each of the plurality of receptacles 60 should have a respective water distribution mechanism 70 coupled thereto. In other words, along the length of the plurality of fluid delivery conduits 14, there should be an equal number of the plurality of receptacles 60 and the plurality of water distribution mechanisms 70. The coupling mechanism used to connect the water distribution mechanism 70 to the plurality of receptacles can be any number of mechanical couplings, such as a threaded coupling, a jaw coupling, a sleeve coupling, a flange coupling, a gear coupling, a magnetic coupling, a or “Hooke's Joint” type coupling.

In accordance with aspects herein, the water distribution mechanism 70 depicted in FIGS. 3 and 4 may spray in a linear pattern, a “cone” pattern, an angled pattern, or may spray in a full 360 degrees. Moreover, in the event that the water distribution mechanism 70 sprays in a linear pattern, a “cone” pattern, or an angled pattern, it is understood that the specific direction that the water distribution mechanism is spraying may change over time. The directional change discussed herein may be controlled mechanically or electronically by way of coupling to a computing device.

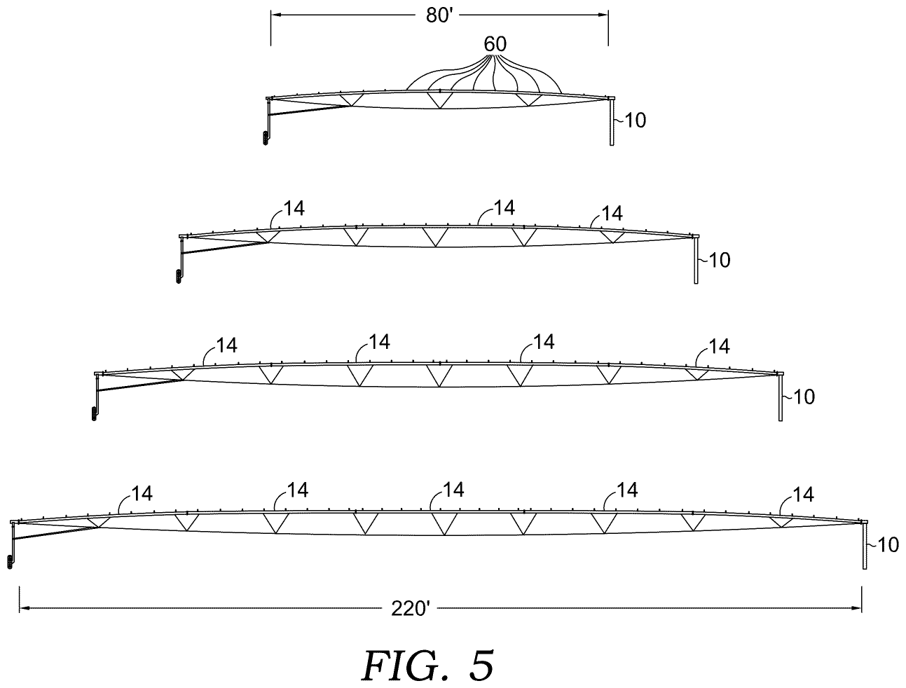

Turning now to FIG. 5, a schematic side elevation view of spans of variable length are depicted. The spans have a plurality of receptacles 60 in accordance with aspects hereof. In FIG. 5, each of the examples are depicted as a single span. However, as discussed herein, the concept of multiple span irrigation systems is heavily contemplated. In aspects in which multiple spans are used, a first span and a second span would be coupled together and supported by a tower, which is discussed further herein. Thus, in some embodiments the desired coverage of the irrigation system 10 may be achieved by a single span or by multiple shorter spans to achieve the same length. In other words, as discussed herein, an irrigation system may be a single span or multiple spans coupled together (e.g., via span coupling(s) as described in FIGS. 12A though 19).

When looking at FIG. 5, it is important to note that the spacing between each of the plurality of receptacles 60 remains constant regardless of the number and total length of the plurality of fluid delivery conduits 14. For example, the span at the top of FIG. 5 is illustrated to be 80 feet in total length and the span at the bottom of FIG. 5 is illustrated to be 220 feet in total length. However, despite the difference in length between these two irrigation systems, the spacing between each of the plurality of receptacles remains 5 feet, even across a coupling between two fluid deliver conduits 14. It is important to note that in illustrated embodiments in FIG. 5, each of the plurality of fluid delivery conduits 14 is the same length across the entire length of each span. Specifically, the span at the top of FIG. 5 contains two 38′ fluid delivery conduits 14, while the span directly beneath it contains three 38′ fluid delivery conduits 14. In other words, each of the spans depicted in FIG. 5 contains a plurality of fluid delivery conduits 14 having the same standard 38′ length throughout the overall length of the span.

Moreover, it is contemplated herein that the receptacle spacing remains constant across the length of each span, although the actual value for the spacing between the plurality of receptacles 60 may also change based on irrigation requirements. For example, if a setting where an agricultural product requires a lot of water, then the spacing between each of the plurality of receptacles 60 may be as low as 2 feet. In another scenario where the agricultural product requires less water, the spacing between each of the plurality of receptacles 60 may be as much as 5 feet. Embodiments where the spacing between each of the plurality of receptacles 60 are 30 inches or 60 inches have been found beneficial. When choosing the overall length of the each span, the spacing between each of the plurality of receptacles 60 must be taken into account. For example, if the spacing between each of the plurality of receptacles 60 is 5 feet, then the overall length of the span must be divisible by 5 feet, so as to maintain uniform spacing between each of the plurality of receptacles 60. Likewise, if the spacing between each of the plurality of receptacles 60 is 2 feet, then the overall length of the span must be divisible for 2 feet. In other words, any spacing between each of the plurality of receptacles 60 is contemplated herein, as long as the overall length of the span allows for the uniform spacing to remain present. Please note that within this disclosure, the length of 5 feet (or 60″) is frequently referred to as the spacing for each of the plurality of receptacles, although in accordance with aspects herein, any of the spacings discussed herein are able to be substituted in place of the 5 feet receptacle spacing length.

Generally, it is advantageous to use the smallest number of fluid delivery conduits 14 within a single span or irrigation system 10. However, there instances where using a larger number of fluid delivery conduits 14 may allow for increased length variability or structural rigidity. For example, there may exist an application in which a non-standard length of a span or irrigation system 10 may be desired. In this case, the desired non-standard length may only be achieved through the use of numerous smaller fluid delivery conduits 14. However, as all the fluid delivery conduits 14 are of the same standard 38′ length, the receptacle spacing remains uniform across all of the fluid delivery conduits 14. But, span lengths may only be modified in multiples of 5′, to maintain the uniform receptacle spacing.

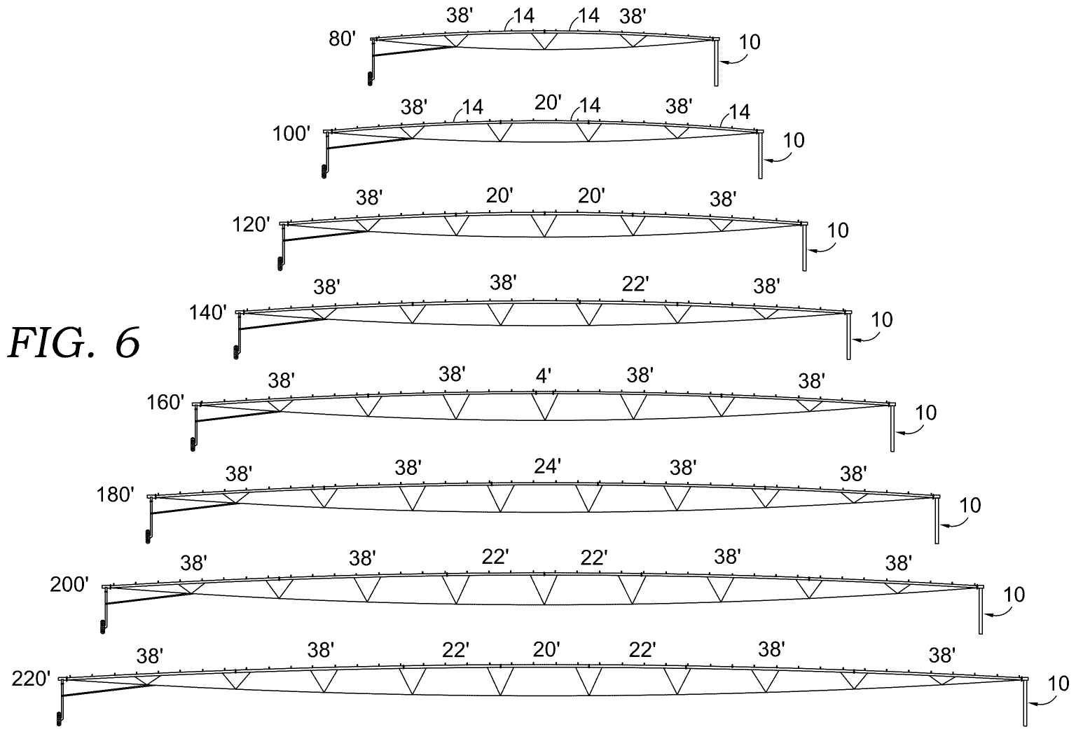

Turning now to FIG. 6, a schematic side elevation view is provided where a plurality of variable length spans are depicted having a plurality of receptacles 60 spaced in accordance with the present invention. In FIG. 6, the fluid delivery conduits 14 are of different lengths across the overall length of the span. For example, the 100′ span contains two standard 38′ fluid delivery conduits 14 spaced apart by and connected together with one intermediate 20′ fluid delivery conduit 14. Moving down the page, each of the plurality of fluid delivery conduits 14 contain a combination of standard 38′ fluid delivery conduits, and other non-standard sized fluid delivery conduits 14. For example, the 140′ span contains three 38′ fluid delivery conduits 14 and one 22′ fluid delivery conduit 14. In another example, the 160′ span contains four 38′ fluid delivery conduits 14 and one 4′ fluid delivery conduit 14. Any combination of standard sized 38′ fluid delivery conduits 14 and non-standard sized fluid delivery conduits 14 (of any length) may be combined to create a desired overall length of a span. Regardless of the desired overall length of the span, each span still has a first end segment 20 at its first end 40 and a second end segment 22 at its second end 42. The first end segment 20 is coupled to the fluid source 12 or the second end segment 22 of an adjoining additional span. The second end segment is coupled to the first end segment 20 of an adjoining prior span or to an ancillary span or a swing arm.

As discussed herein, the first end segment 20 and the second end segment 22 are sized to be two feet in length (plus or minus 10%), such that when multiple spans are connected to each other, the spacing of the plurality of receptacles 60 remains constant from one span to the adjacently-connected span. For example, in FIG. 6, if the 80′ span and the 100′ span are coupled to each other, the sizing of the first end segment 20 and the second end segment 22 allows for the spacing of the plurality of receptacles 60 to remain constant across the connection between the spans that have been coupled together. By having a constant spacing of the plurality of receptacles 60 across multiple spans, this reduces the number of “dead zones”, in which crops receive no, little, or excess active water supply. In other words, in prior art irrigation systems, the coupling of multiple spans together of non-standard lengths would result in “dead zones” (i.e., areas where the receptacles are closer than normal or further apart than normal) at the location of coupling, because the constant spacing of the plurality of receptacles 60 gets interrupted by the sizing of the coupling joints. However, in accordance with the invention of this application, the first end segment 20 and the second end segment 22 are sized, along with the positioning of the receptacles 60 along each fluid delivery conduit 14, to prevent a “dead zone” from arising. By having the first end segment 20 and the second end segment 22 having the appropriate size (2 feet) in the present application, the spacing of the plurality of receptacles 60 remains a constant 5 feet across the connections of multiple spans, as well as along each span, for the length of the irrigation system 10.

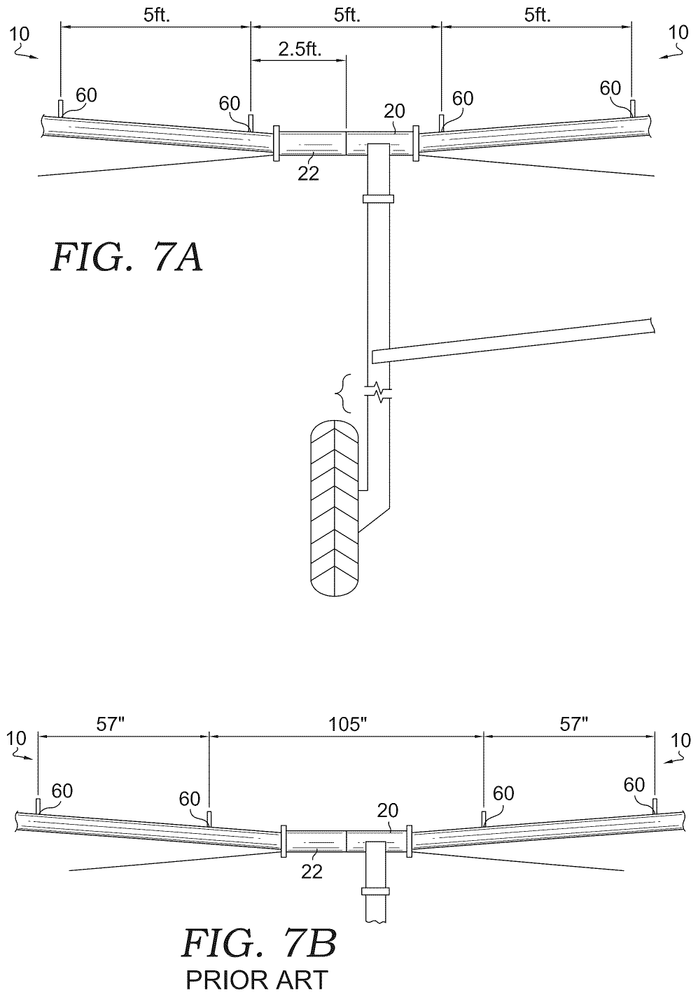

The concept of preventing “dead zones” (areas which receive no, little, or excess active water supply) is best illustrated within FIGS. 7A and 7B. FIG. 7B depicts a prior art coupling of two spans, depicting the non-uniform spacing of receptacles 60 that happens when two prior art spans are coupled together. Note the spacing between adjacent receptacles 60 is non-uniform due to the sizing of the prior art spans or the presence of the first end segment 20 and second end segment 22. On the other hand, FIG. 7A depicts two spans of the irrigation system 10 that have been coupled together in accordance with aspects of the present invention. The span on left side of FIG. 7A and the span on the right side of FIG. 7A are coupled together by a first end segment 20 and a second end segment 22. In accordance with aspects of the present invention, the length of each of the first end segment 20 and the second end segment 22 is two feet, and the spacing between each of the plurality of receptacles 60 is 5 feet. Thus, there is roughly a ½ foot gap between each of the final receptacles 60 and the first end segment 20 and the second end segment 22. In sizing each of the first end segment 20 and the second end segment 22 this way, the spacing between each of the plurality of receptacles 60 remains constant (5 feet) across the connection of the two spans, even though they have been coupled together.

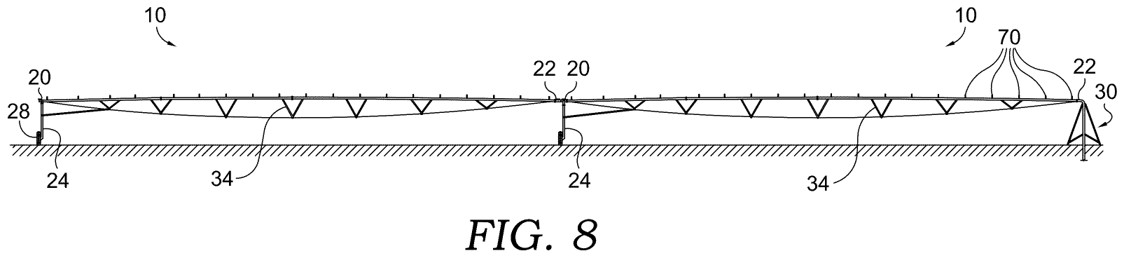

Turning now to FIG. 8, a side elevation view of two spans coupled together is presented, in accordance with aspects of the invention. In examples, the spans can be coupled (at least in part) via any of the couplings described with respect to FIGS. 12A to 19. The coupling between the spans occurs at the first end segment 20 and the second end segment 22. In addition, the parts associated with the coupling can be appropriately sized to prevent a “dead zone” from arising. As depicted in FIG. 8, the spacing between each of the plurality of receptacles 60 remains constant across each span within the irrigation system 10. On the right portion of the illustration, a stationary tower 30 is depicted as providing the fluid source 12 to the array of spans, and on the left portion of the diagram, a mobile tower 24 with a wheel 28 is depicted as allowing for the array of spans to pivot and rotate around the stationary tower 30. As discussed herein, the first end segment 20 and the second end segment 22 are approximately two feet in length (plus or minus 10% for tolerancing), such that the spacing between each of the plurality of receptacles 60 remains 5 feet. Moreover, as depicted in FIG. 8, each of the plurality of receptacles 60 contains a water distribution mechanism 70, depicted in FIG. 8 as a sprinkler. It is within the scope of this disclosure to have other types of water distribution mechanisms 70 coupled to the plurality of receptacles 60. The general goal of the water distribution mechanism is to disperse water (or another type of liquid) in an efficient manner, across a large area.

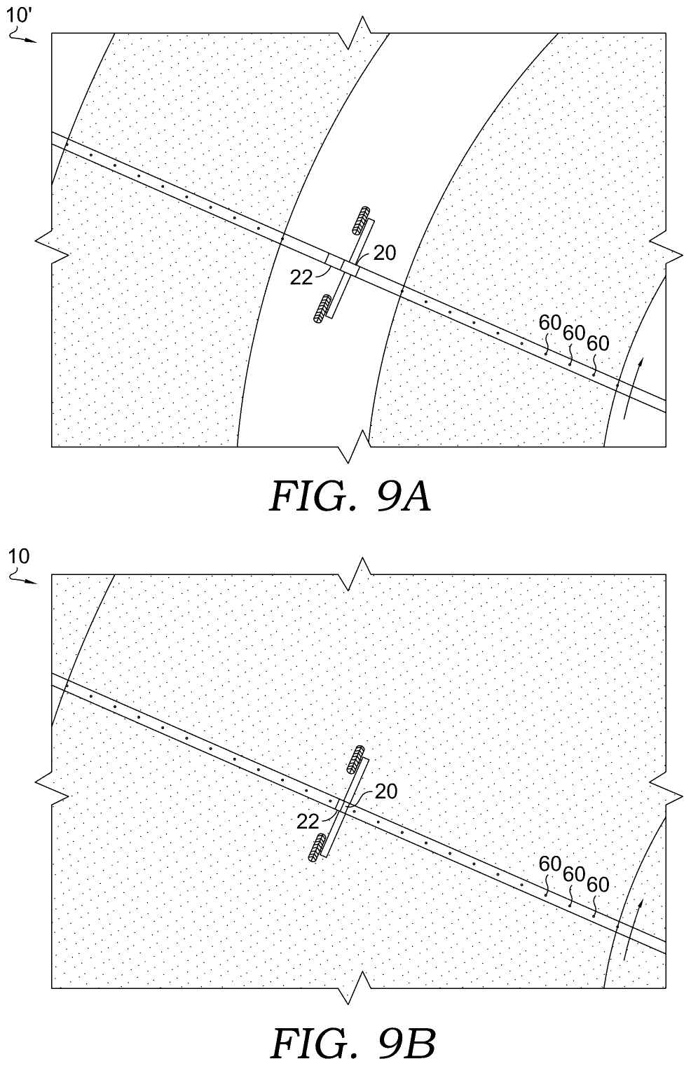

Turning now to FIG. 9A, an environmental top view of a prior art irrigation system 10′is depicted. FIG. 9B provides an environmental top view of an irrigation system 10 constructed in accordance with the present invention. As depicted in FIG. 9A, the constant spacing between the plurality of receptacles 60′ along the span is interrupted when the two spans 10 are coupled together. This leads to the creation of a “dead zone”, in which water (or another fluid) does not touch every portion of the ground in the area within the radius of the prior art irrigation system 10′. By contrast, in FIG. 9B, the irrigation system 10 of the present invention maintains a constant spacing between the plurality of receptacles 60 across the connection between two spans, such that water (or another fluid) touches every portion of the ground in the area within the radius of the irrigation system 10 of this application. The stippled portions of FIGS. 9A and 9B represent agricultural areas which would receive water and the areas without stippling represent the agricultural areas which would not receive any water or very little water. FIG. 9A represents the issues with the prior art irrigation systems, in which the sizing of the prior art first end segment 20′ and prior art second end segment 22′ prevents the water distribution from reaching the entirety of the surrounding crops. However, in FIG. 9B (which represents the invention of the present application), the sizing of the first end segment 20 and the second end segment 22 allows the plurality of receptacles 60 to span the length of the plurality of fluid delivery conduits 14. By doing so, the fluid that comes from the plurality of fluid delivery conduits 14 covers the entire ground beneath (as illustrated by the stippling in FIG. 9B).

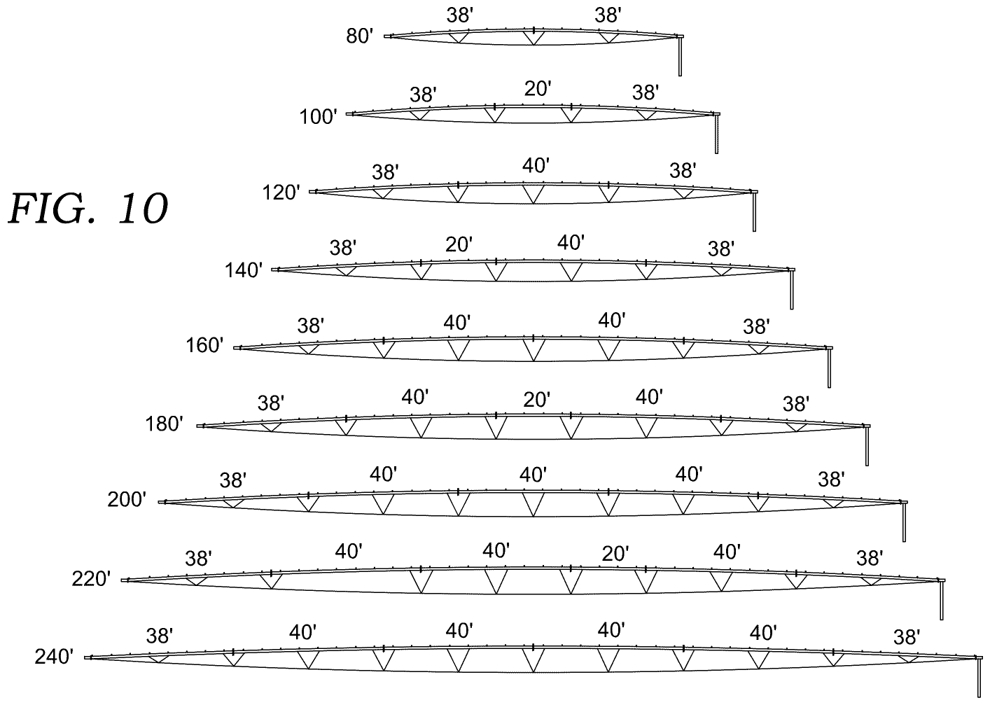

In FIG. 6, the plurality of pipe segments 14 are generally depicted as having lengths of 4′, 20′, 22′ or 38′, in accordance with aspects herein. This combination of pipe segments 14 with the receptacle spacing thereon permits pipe segments 14 of only four different lengths to provide for span lengths of 80′ to 220′ in 20′ increments with uniform receptacle spacing across adjoining pipe segments 14 and across adjoining spans. Further, each of the four pipe segments 14 are of a length that easily fits into a standard shipping container. However, it should be understood that the lengths of these pipe segments 14 is merely exemplary for one embodiment of the concepts of the present invention. The concepts of the present invention described herein may be used with pipe segments 14 of different lengths and still be within the scope of this disclosure. For example, FIG. 10 depicts a schematic side elevation view of an alternate embodiment of a variable length span of an irrigation system having uniformly spaced receptacle portions and uniform pipe lengths. In this embodiment the receptacles 60 are spaced on 60″ intervals and the lengths of some of the fluid delivery conduits 14 are different in some of the overall spans when compared to FIG. 6. The span lengths in FIG. 10 are accomplished through the use of individual pipe segment lengths that are 20′, 38′ and 40′. Accordingly, this embodiment provides for pipe segments of only three different lengths to provide for span lengths of 80′ to 240′ in 20′ increments while still providing uniform receptacle spacing across adjoining pipe segments 14 and across adjoining spans.

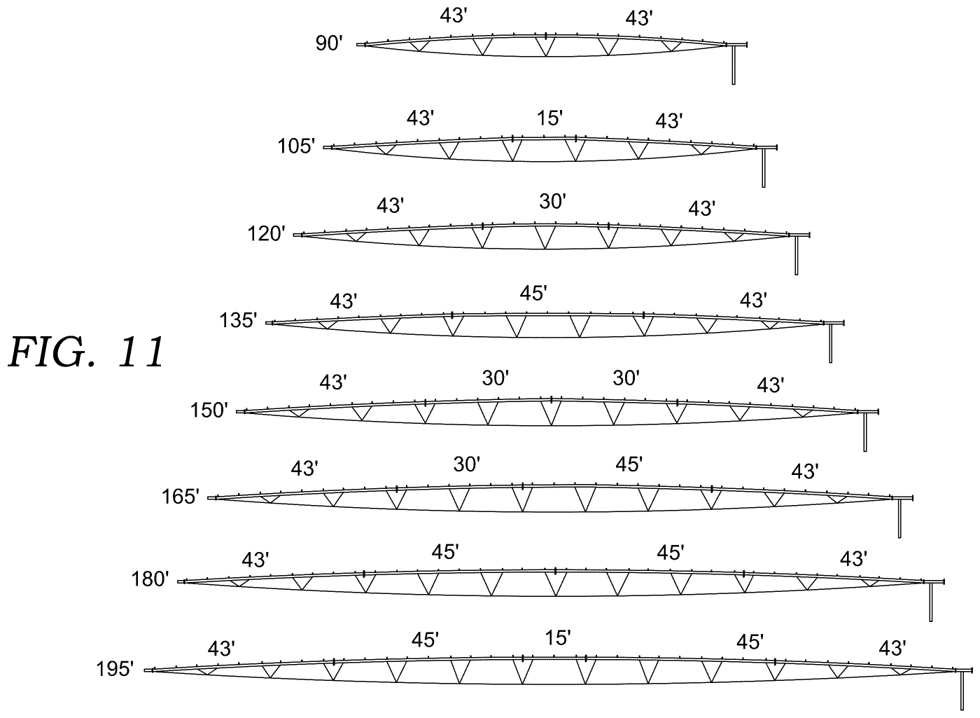

FIG. 11 depicts a schematic side elevation view of yet another embodiment of the present invention. In this embodiment, unlike those in FIGS. 6 and 10 where the span lengths were in 20′ increments, the overall lengths of the spans run from 90′ to 195′ in 15′ increments. This is accomplished by utilizing individual pipe segments of 15′, 30′, 43′ and 45′. Accordingly, in this illustrated embodiment, pipe segments of only four different lengths are needed to provide the entire range of span lengths, thereby minimizing the number of standard pipe lengths needed for the family of span lengths while still providing for uniform receptacle across the entire length of the irrigation unit. As discussed herein, the overall lengths of the spans, as well as the lengths of the individual pipe segments is variable depending on the needs of the user. Therefore, it should be understood that the lengths depicted herein are merely examples, rather than a rigid representation of dimensions of the invention. Most importantly, the actual values of the overall span lengths and individual pipe segments allows for a uniform distribution of the plurality of receptacles 60. It should be understood that these embodiments are merely exemplary, and that other overall span lengths and lengths of individual pipe segments are contemplated to be within the scope of this disclosure.

The irrigation systems of the present disclosure can include various span couplings. This detailed description is related to an irrigation system pipe joint, which can connect a span of an irrigation system to another structure and can enable the span to more efficiently rotate or pivot in one or more axes of motion with reduced part wear. In examples, the joint can include various components that attach an end of a first pipe or joint to an end of a second pipe or joint. For example, the end of the first joint can include a receiver plate, which can include a recess with a bushing. In addition, the end of the second joint can include a post, hook, or other elongated member that, in order to connect the first joint to the second joint, is insertable into the bushing. In examples, based on the elongated member (e.g., post, hook, or other) being inserted into the recess and bushing, the first joint and/or the second joint can rotate relative to one another. Furthermore, based at least in part on the bushing, relative movement between the joints can be efficient and associated with reduced part wear or reduced damage (e.g., of the recess and the elongated member) and a precision alignment connection can be achieved between joint members.

In examples, the bushing can have various elements that contribute to efficient pipe motion and reduced part wear or reduced damage. In some instances, the bushing can include a recess configured to receive the elongated member. For instance, the bushing recess may include a profile shape and/or size that corresponds with an elongated member. As such, the elongated member closely mates with the receiver plate, which can reduce excess shifting of the elongated member in the receiver plate recess and can increase the likelihood that relative motion of the first pipe and the second pipe occurs at a common, center of rotation (e.g., where the pitch, yaw, and roll axes intersect).

In some examples, the bushing recess can include one or more surface features that can contribute to efficient pipe motion and reduced part wear or reduced damage. For example, perimeter walls of the bushing recess can include one or more chamfers or curved edges, which can transition from a wider opening to a narrower central portion (e.g., waist). As such, the bushing can closely fit around the elongated member, and the elongated member can rotate or pivot with limited resistance when retained in the bushing.

Among other things, the span coupling (e.g., including a bushing) enables spans of an irrigation system to efficiently maneuver along multi-axial motion paths. For example, a bushing, as described herein and based on the close fit with the elongated member, can limit erratic movement (e.g., side-to-side, fore-and-aft, etc.) of a hook plate relative to a receiver plate. As such, based on the limited erratic movement, the span coupling maneuvers at a relatively consistent rotation axis. In addition, the bushing can reduce friction associated with yaw-type rotation of the coupled parts (e.g., as the bushing spins in the receiver plate recess).

In some examples, as depicted in FIGS. 1 and 2, the system 10 can include one or more span couplings 110 (e.g., connecting a span to a fluid source and/or connecting a span to another span or to another structure). Referring now to FIGS. 12A and 12B, an example span coupling 310 is described in more detail, and any of the span couplings 110 can include the span coupling 310. In examples of the present disclosure, the span coupling 310 includes a first joint 312 coupled to a second joint 314, and the joints 312 and 314 can include a pipe segment or other tubular structure. In addition, span coupling 310 can include a boot 316, hose, or other flexible tube structure that is coupled to the joints 312 and 314 (e.g., such as via boot connectors 318 and 320, such as clamps), and for illustration purposes, the boot 316 is depicted as partially cutaway in FIG. 12B. In examples, the first joint 312 includes a first terminal end 322; the second joint 314 includes a second terminal end 324; and the boot 316 encloses the interstitial space between the terminal ends 322 and 324. In some examples, the boot 316 and the connectors 318 and 320 functionally seal the connection between the joints 312 and 314, such as to allow for fluid to be contained or flowed through the joints 312 and 314 with minimal leaking.

With continued reference to FIG. 12B, in some examples, the first joint 312 and the second joint 314 are connected via one or more structures that facilitate relative movement therebetween. In addition, the flexibility of the boot 316 allows for the connection between the pipes to remain relatively sealed, even when the joints 312 and 314 move relative to one another. For instance, in at least some examples, the first joint 312 includes a hook 326 (e.g., hook plate) coupled to the first terminal end 322, and the hook 326 can include a point 328. Although the span coupling 310 includes the hook 326, in other examples, the span coupling 310 can include alternative structures with elongated members that are structurally similar to the point 328, such as posts, pins, and the like. In examples, the hook 326 can include a dimension (e.g., height) that is similar to the inner diameter of the joint 312, and the hook 326 can be welded or otherwise fused to the inner wall/surface of the joint 312. In some examples, the second joint 314 includes a receiver plate 330 with a recess configured to mate with the point 328 of the hook 326, and similar to the hook 326, based on the receiver plate 330 having a dimension similar to the inner diameter of the joint 314, the receiver plate 330 can be welded (or otherwise fused) to the inner wall/surface of the joint 314. In some examples, the point 328 can be inserted through the recess and retained in the recess to connect the first joint 312 to the second joint 314.

In examples, the span coupling 310, including the hook plate 326 and receiver plate 330, is robust, strong, and sufficient to support the load-bearing requirements of the span, while also providing multi-axial degrees of motion freedom. As such, one part of the span coupling (e.g., hook side) can maneuver (e.g., as the system traverses varied terrain) relative to the other part of the span coupling (e.g., receiver side). In some examples, within a span coupling 310, the receiver plate 330 may be positioned closer (relative to the hook plate 326) to the tower. For example, in span coupling that attaches two spans together, the receiver plate (or the joint 314) can be coupled to a first span, whereas the hook plate (or the joint 312) can be coupled to the other span. In other examples, within a span coupling 310, the hook plate 326 can be positioned at the tower. For example, the hook plate 326 can be installed tower-side with the point 328 pointed upwards and the receiver plate 330 (span side) can be installed atop the point 328 of the hook.

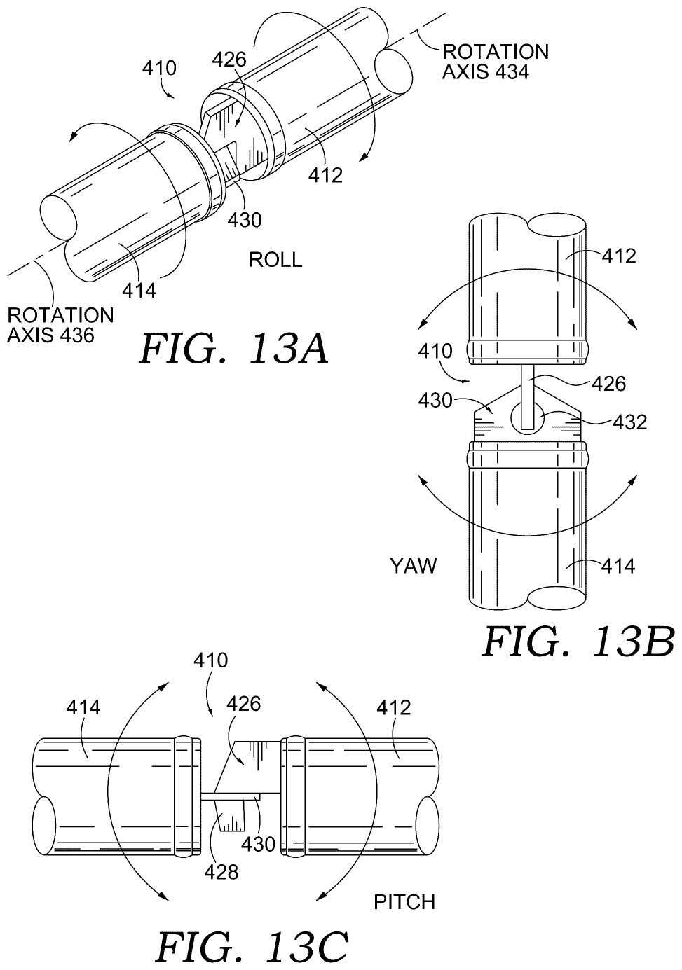

Referring now to FIGS. 13A, 13B, and 13C, examples of relative motion between pipes or joints are depicted. That is, FIGS. 13A, 13B, and 13C depict an example connection 410 between joints 412 and 414 that are similar to the joints 312 and 314. For example, the joints 412 and 414 includes a hook 426 and a receiver plate 430, respectively, and FIG. 13B depicts a recess 432 of the receiver plate 430, the hook 426 being received in the recess 432. In addition, the connection 410 between the joints 412 and 414 could include a boot, which is omitted from FIGS. 13A, 13B, and 13C for illustrative and explanatory purposes, and the flexibility of the boot can help maintain a seal between the joints 412 and 414 when the joints move relative to one another.

As explained above with respect to the joints 312 and 314, the joints 412 and 414 can include relative motion with respect to one another. For example, as depicted in FIG. 13A, the one or more of the joints 412 and 414 can rotate or “roll” around an axis (e.g., 434 and/or 436) that is coaxial with an axis or axes of the joints 412 and 414, such that the hook 426 (e.g., the point 428 (FIG. 13C) of the hook 426) rotates or pivots relative to the receiver plate 430. In addition, as depicted in FIG. 13B, one or more of the joints 412 and 414 can rotate or “yaw” around a rotation axis that is parallel with (e.g., coaxial with) an axis of the recess 432. Further, in some instances, one or more of the joints 412 and 414 can rotate or “pitch” around an axis that is perpendicular to one or more of the axes 434 or 436 and to the axis of the recess 432. In examples, the joints 412 and 414 can move in one or more of the degrees of motion represented by FIGS. 13A, 13B, and 13C (e.g., roll, yaw, and pitch).

In examples, components of the connection 310 or 410 (e.g., hook or hook plate and receiver plate) can be made of various materials, including ferrous and non-ferrous materials. In addition, the connections 310 and 410 are configures to support the load-bearing requirements of the span while also providing three degrees of freedom, for the span to maneuver and adjust as the system (e.g., 10) traverse a ground surface. In addition to enabling the structural connections across the systems (e.g., at 110 or at any connection of a span to another structure), the connections 310 and 410 can allow fluid to transfer from one span to the next. In examples, the hook plate 326 or 426 and the receiver plate 330 or 430 are designed to be internal to the irrigation pipes or joints about the central axis for system alignment and control. In examples, the hook plate and receiver plate connection being proximate to the centerline of the irrigation pipe (e.g., aligned with the axes 434 and 436) can also provide a more accurate connection on rough terrain and can facilitate a higher degree of rotational movement (e.g., as compared to connections in which the plates are not aligned with the center line).

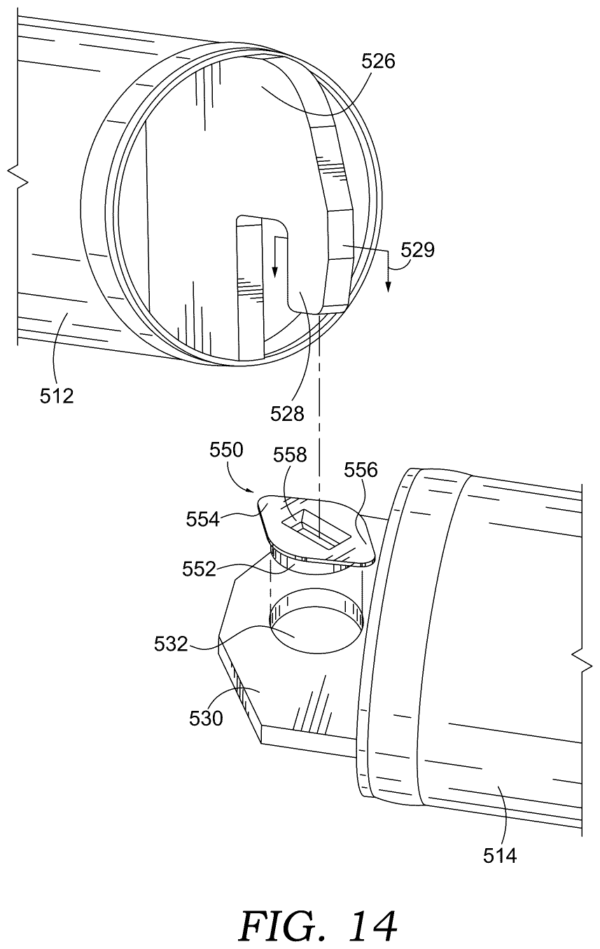

Referring to FIG. 14, in some examples of the present disclosure, the span coupling (or connection between pipes or joints) can include additional components to provide more efficient, consistent, and precise movement between the pipes and/or joints and to better align the pipes or joints. For example, FIG. 14 depicts a first joint 512 (e.g., similar to the joints 312 and 412) with a hook plate 526 and a second joint 514 with a receiver plate 530. In addition, the connection includes a bushing 550 that is insertable in the recess 532 of the receiver plate 530, and the bushing 550 can include various features configured to nest in the recess 532 and mate with the point 528 of the hook 526. For example, the bushing 550 can include a cylindrical or disc-like body 552 having a dimension (e.g., width, diameter, circumference, etc.) configured to fit within the recess 532 and one or more flanges 554 and 556 (e.g., triangular tabs or lobes or circumferential lip) that protrude outward from the bushing body 552 and support the bushing 550 relative to the receiver plate 530 (e.g., support the bushing 550 on top of the receiver plate 530). In at least some examples, the fit between the recess 532 and the body 552 can include an interference fit, and as used herein, an interference fit can include zero to negative clearance). In examples, as explained in other portions of this disclosure, the bushing 550 can be configured to reduce friction between the hook plate 526 and the receiver plate 530 (e.g., reduce metal-on-metal wear) and to more precisely align the hook plate 526 and the receiver plate 530.

In examples of the present disclosure, the point 528 of the hook 526 (or other elongated member) can include a two-dimensional profile at a cross section aligned with reference position 529 (e.g., in a reference plane that is perpendicular to the plate body of the hook 526 and is coaxial with the pipe 512). For example, the two-dimensional profile can include a rectangle. In addition, the bushing 550 can include a recess 558 at least partially enclosed around the sides by a perimeter wall comprising a recess perimeter profile shape that corresponds with the two-dimensional profile of the point 528. Furthermore, the dimensions of the recess (e.g., width) can be configured for tight fitment with the point 528 of the hook 526. In FIG. 14, the point 528 includes a relatively straight or linear configuration in the longitudinal axis (e.g., perpendicular to the reference position 529). For example, the edge 531 is relatively straight. In an alternative example, the edge 531 can be more curvilinear or arcuate.

In some examples, the bushing 550 can (e.g., based on a fit within the recess 532 and with the point 528) reduce erratic movement between the hook plate and the receiver plate, which can reduce metal-on-metal wear over time. In addition, the bushing 550 can be constructed of various materials (e.g., high-density polyethylene (HDPE) or ultra high molecular weight polyethylene (UHMWPE)) that reduce friction associated with the bushing 550 rotating, spinning, or turning within the recess 532. Further, liquid passing through the pipeline when in use can keep the bushing 550 lubricated and can lower the coefficient of friction, thus improving the bearing surface for the hook 526. In addition, when installed and providing a coupling between the hook 526 and the receiver plate 530, the bushing 550 can be under tension based on various forces acting on the bushing 550 from different directions (e.g., tension between the hook to bushing and between bushing to receiver). Among other things, these forces and the resulting tension can diminish motion in various directions (e.g. fore-to-aft and side-to-side), as the hook can remain seated against the receiver on the downstream side. In some examples (e.g., in both a center pivot or lateral-move system), water pressure in the pipeline can also contribute to the tension and seating of the bushing, and in the case of center pivots, the outward movement or bias can also contribute to these different forces acting upon the system. Furthermore, in some examples, the weight of the span can provide enough force to help retain the hook within the bushing (e.g., reduce the likelihood that the hook disengages. In addition, the boot (e.g., 316) that surrounds the hook and receiver plates can also help hold the coupling position together, which can reduce the likelihood that the connection becomes unseated. This can, in some instances, operate as a form of static restraint to the connection.

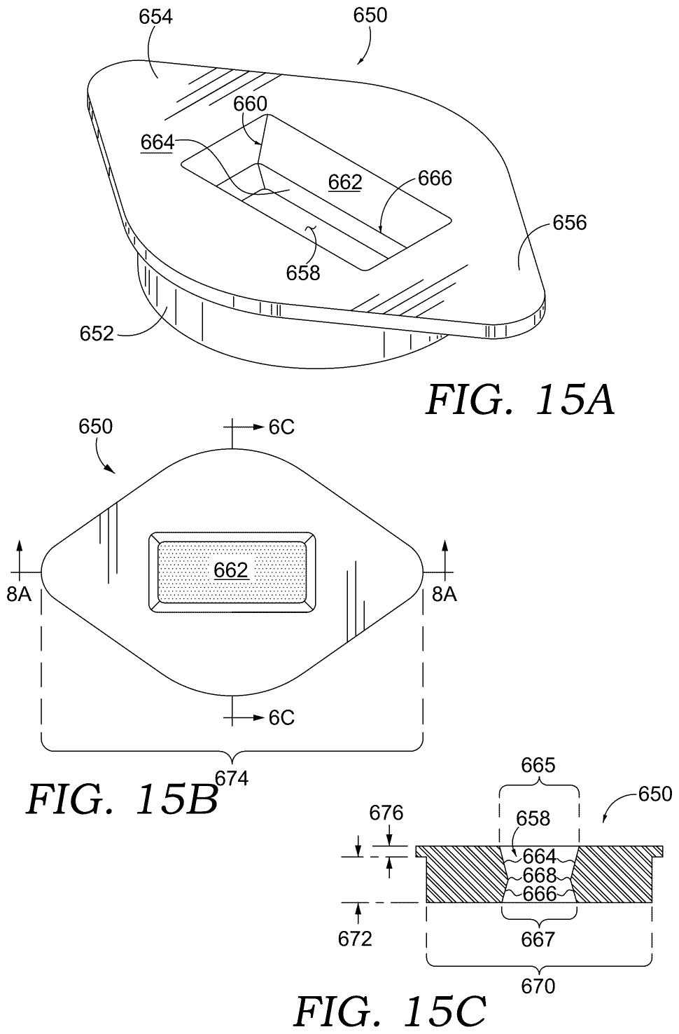

Referring to FIG. 15A, an example bushing 650 is depicted, and FIG. 15B depicts a plan view of the bushing 650. In addition, FIG. 15B illustrates a reference line 15C-15C associated with the cross-sectional view depicted in FIG. 15C. In examples, the bushing 650 can include similar elements to the bushing 550 (and vice versa). For example, the bushing 650 includes a bushing body 652, flanges 654 and 656, and a recess 658. In addition, the recess 658 includes a perimeter wall 660 that at least partially bounds and encloses sides of the recess 658, and based on the perimeter wall 660, the recess 658 can include a profile shape (e.g., rectangular). For instances, the plan view in FIG. 15B depicts an example rectangular profile shape 662, which is shown in stipple shading for illustration purposes.

In some examples, the perimeter wall 660 can include a one or more chamfers. For example, the perimeter wall 660 can include a top chamfer 664 (e.g., chamfered wall), such that the perimeter wall 660 tapers from a larger insertion opening 665 (e.g., through which the hook point 528 is inserted) to a narrower, central portion of the recess 658. In addition, the perimeter wall 660 can include a bottom chamfer 666, such that the perimeter wall 660 tapers from a larger exit opening 667 (e.g., from which the hook point 528 exits when inserted through the recess 658). In some examples, the top and bottom chamfers 664 and 666 can converge at a narrower waist 668 of the recess 658, and in some examples, the narrower waist 668 is positioned about half of a depth of the recess 658. The waist 668 can, in some examples, provide tight fitment on opposing sides of the point 528.

In some examples, the perimeter wall includes a top portion that circumscribes the busing recess and that comprises the top chamfer 664, a bottom portion that circumscribes the bushing recess and that comprises the bottom chamfer 666, and the top portion and the bottom portion converge at the narrowed recess waist 668 that also circumscribes the bushing recess. In the FIGS. 15A-15C, the top and bottom portions frame a rectangular recess, and in other examples, the top and bottom portions can frame a circular recess, which can be useful when the hook or other elongated member is cylindrical. Among other things, the bushing recess 658 comprising circumscribing chamfered portions can contribute to smooth transitions between, or combinations of, rolling and pitching.

The bushing 650 can include various other dimensions. For example, the bushing 650 can include a base width 670 (e.g., diameter) configured to fit snuggly within the recess 532 of the receiver plate 530 (e.g., an interference fit), as well as a base height 672 that is similar to a thickness of the receiver plate 530. In examples, based on the base width 670 being configured to snuggly fit within the recess 532, the bushing 650 can contribute to limited erratic movement (e.g., side-to-side and fore-to-aft) relative to the recess 532. In addition, the bushing can include a flange width 674 that is larger than the base width 670 and is configured to support the bushing 650 relative to (e.g., against or on top of) the receiver plate 530. In examples, the flange width 674 (as well as the flange thickness 676) can be configured to impede the bushing 650 from being pushed through the recess 532 of the receiver plate 530.

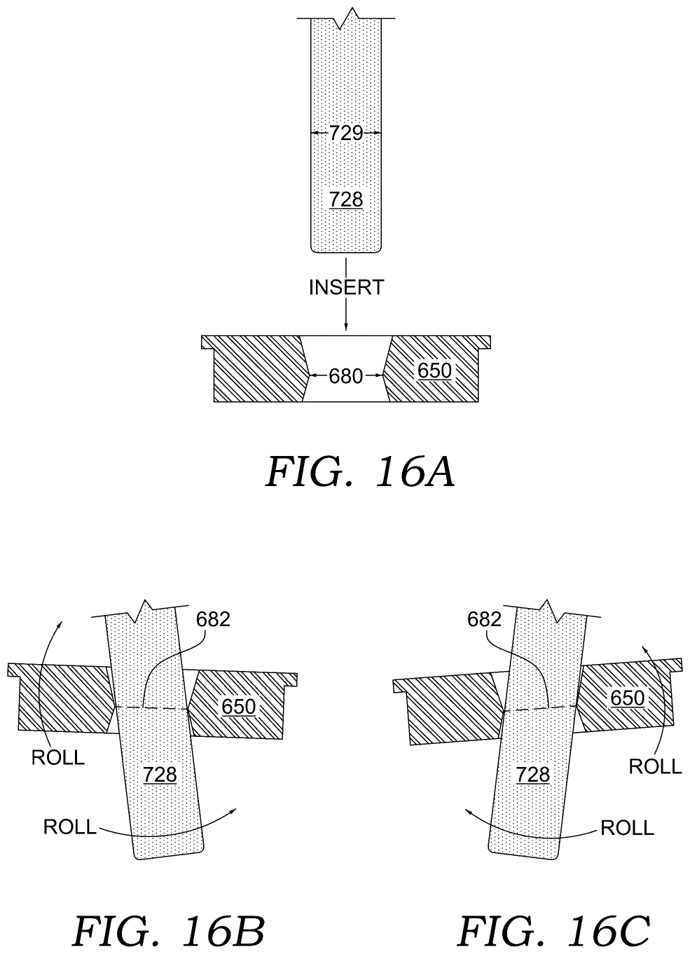

Referring to FIGS. 16A, 16B, and 16C, cross sections of the bushing 650 (e.g., similar to FIG. 6C) and a hook point 728 are depicted, the hook point 728 being insertable within the recess 658 of the bushing 650. In examples, the hook point 728 can include features similar to the point 528. Among other things, FIGS. 16B, and 16C depict roll movement (e.g., FIG. 13A) of the point 728 relative to the bushing 650 (e.g., the point 728 forming part of an installed hook plate and the bushing 650 being installed in a receiver plate).

The bushing 650 can include various features to contribute to efficient roll-type relative movement. For example, the bushing 650 can include a waist width 680 that is similar to a point thickness 729 (or thickness of other elongated member), which can contribute to a fit configured to control relative movement. In some examples, the fit between the hook and the bushing can include a “slip fit,” and as used herein, a slip fit can include positive clearance between the parts. In some examples, the waist width 680 is within a range of about 1.0× to about 2.0× of the point thickness 729; or about 1.0× to about 1.5× of the point thickness 729; or about 1.0× to about 1.25× the point thickness 729. However, these tolerances are examples, and in some instances, the waist width 680 can be smaller than 1.0× of the point thickness 729 or can be larger than 2.0× of the point thickness 729. Among other things, the waist width 680 being similar to the point thickness 729 can reduce erratic (e.g., side-to-side) movement of the point 728 relative to the bushing 650 and to the receiver plate. In addition, as illustrated by FIGS. 16B and 16C, the waist 668 can function as a fulcrum 682 on which the point 728 pivots as one or more of the pipes rolls relative to the other.

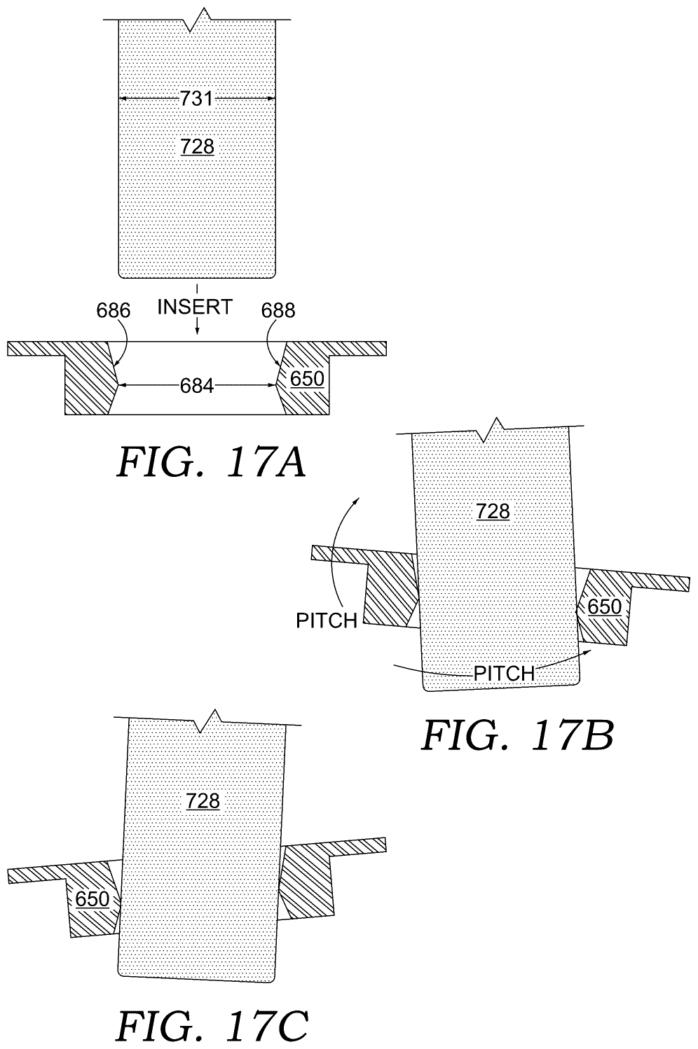

FIGS. 16B and 16C illustrate roll-type movements. Referring to FIGS. 17A, 17B, and 17C, another example is illustrated, including cross-sections of the hook point 728 and the bushing 650 (based on the reference position 17A-17A identified in FIG. 15B). The bushing 650 can include various features to contribute to efficient pitch-type relative movement. For example, the bushing 650 can include a waist length 684 that is similar to a point thickness 731 (or thickness of other elongated member), which can contribute to a slip fit. In some examples, the waist length 684 is within a range of about 1.0× to about 2.0× of the point thickness 731; or about 1.0× to about 1.5× of the point thickness 731; or about 1.0× to about 1.25× the point thickness 731. However, these tolerances are examples, and in some instances, the waist length 684 can be smaller than 1.0× of the point thickness 731 or can be larger than 2.0× of the point thickness 731. Among other things, the waist width 684 being similar to the point thickness 731 can reduce erratic (e.g., for-to-aft in a direction coaxial with the pipes) movement of the point 728 relative to the bushing 650 and to the receiver plate. In addition, as illustrated by FIGS. 17B and 17C, the waist 684 can function as a fulcrum around which the point 728 pivots as one or more of the pipes pitches relative to the other.

FIG. 17A illustrates an embodiment in which the sides or walls 686 and 688 include one or more chamfers that can contribute to efficient movement of the hook plate and the receiver plate relative to one another. In other examples, the sides or walls 686 and 688 can be relatively flat, without a chamfer. In other examples, the sides or walls 686 and 688 can include, at the corner transitioning to the top flanged portion of the bushing 650, a rounded radius (e.g., R0.375) providing a gradual transition into the recess and a rocking surface for the point 728. In some examples, the sides or walls 686 and 688 can be relatively flat without a chamfer or rounded corner.

As depicted in FIGS. 16A-16C and 17A-17C, the bushing 650 (e.g., the recess 658) and the point 728 can include corresponding features, such as profile shapes and dimensions, that contribute to a relatively tight fit between the parts when the point 728 is inserted into the bushing 650. As such, when the hook point 728 and the receiver plate yaw (e.g., FIG. 13B) relative to one another, the bushing 650 can spin within the recess 532 to allow the hook plate to efficiently move (e.g., with low friction and reduced erratic movement) relative to the receiver plate. In addition, as described with respect to FIG. 14, when installed and providing a coupling between the hook and the receiver plate, the bushing 650 can be under tension based on various forces acting on the bushing 650 (e.g., tension forces between the hook and bushing, between the bushing and receiver, from the water pressure, and in center pivots, due to the outward motion). Among other things, these tensions or forces that can be in different directions can help maintain a stable coupling with relatively limited motion in various axes (e.g., fore-and-aft, side-to-side, etc.).

In other examples, the hook point 728 (or other elongated member) can include a circular cross section and the bushing recess can include a corresponding circular profile, such that the hook point 728 spins in the yaw axis relative to the bushing (as opposed to the bushing spinning relative to the receiver plate). Although the figures illustrate some movements independently of others, it is understood that the pipes can undergo movement in any combination of roll, yaw, and pitch. In examples, the bushing 650 facilitates efficient movement in any of these combinations and, based on the relatively tight fit of the components, around a relatively fixed rotation axis.

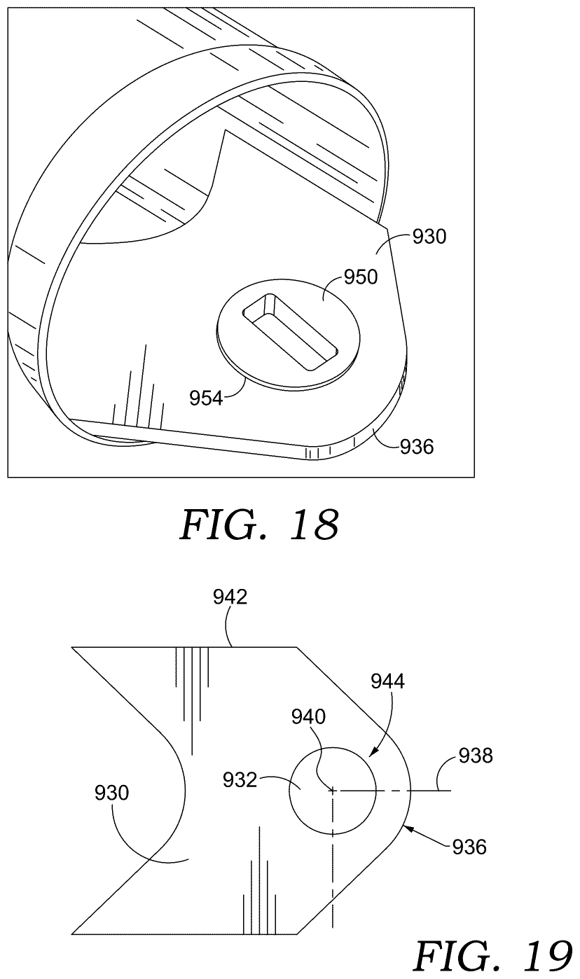

The span joints (e.g., 110) can include one or more other elements. For example, referring to FIGS. 18 and 19, an alternative receiver plate 930 is depicted. In examples, the receiver plate 930 includes a recess 932, and a bushing 950 can be inserted into the recess 932. In FIG. 18, the bushing 950 includes a circumferential flange (e.g., ring) 954 having a radius, and in other examples, the bushing 950 could include lobular flanges (e.g., 654 and 656 that together are diamond like). In still other examples, the bushing can include other flange designs, such as square, triangular, or other n-side polygons.

In at least some examples, the receiver plate 930 can include a leading edge 936 shaped with a semi-circular face, which begins at a midline 938 aligned with the center 940 of the recess 932 and extends a slight distance on either side before gradually transitioning to a flatter edge intersecting the side 942 of the receiver plate 930. Among other things, the portion 944 of the receiver plate 930 between the leading edge 936 and the recess 932 is configured to support (e.g., provide a shelf) a load associated with a hook plate (e.g., the hook plate, pipe connected to the hook plate, span associated with the pipe, etc.). In addition, the semi-circular leading edge 936 can provide a motion path along which the hook plate can slide, the motion path being relatively free from corners or edges that might interfere with the motion (e.g., yaw motion) of the hook plate. In other examples, the leading edge of the receiver plate can include bevels or other designs to provide a hook-plate support shelf that is relatively free from obstructions in the motion paths of the hook plate.

As described above, subject matter of this disclosure provides various advantages. Among other things, the span coupling (e.g., including a bushing) enables spans of an irrigation system to efficiently maneuver along multi-axial motion paths. For example, a bushing, as described herein, can limit erratic movement (e.g., side-to-side, fore-and-aft, etc.) of a hook plate relative to a receiver plate. As such, based on the limited erratic movement, the span coupling maneuvers at a relatively consistent rotation axis. In addition, the bushing can reduce friction associated with yaw-type rotation of the coupled parts (e.g., as the bushing spins in the receiver plate recess).

Additionally, although some exemplary implementations of the embodiments described herein are shown in the accompanying figures, these implementations are not intended to be limiting. Rather, it should be understood that the various embodiments and aspects described herein may be implemented upon any irrigation system having a plurality of receptacles along a span.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

What is claimed:

1. An irrigation system comprising:
a plurality of fluid delivery conduits having a plurality of receptacles spaced along the plurality of fluid delivery conduits, wherein the plurality of fluid delivery conduits comprise a span having a first peripheral end and a second peripheral end;
a first end segment coupled to the first peripheral end and a second end segment coupled to the second peripheral end, each of the first end segment and the second end segment having a length that is shorter than a distance between two of the plurality of receptacles, wherein each of the plurality of receptacles are spaced apart by a uniform distance, and wherein the first end segment is coupled, by a span coupling, to another structure comprising another span or a fluid source; and
the span coupling comprising:
an elongated member comprising a first profile shape; and
a receiver plate comprising a first recess and a bushing positioned in the first recess, wherein the bushing comprises a second recess, wherein the second recess includes a perimeter wall comprising a second profile shape, wherein the second profile shape corresponds to the first profile shape, and wherein the elongated member extends through the second recess to join the first end segment to the other structure.

2. The irrigation system of claim 1, wherein the length of the first end segment and the length of the second end segment is less than half of the uniform distance by which each of the plurality of receptacles is spaced apart.

3. The irrigation system of claim 2, wherein the plurality of fluid delivery conduits comprises at least one individual fluid conduit having a first length, and wherein the plurality of fluid delivery conduits comprises at least one individual fluid conduit having a second length that is smaller than the first length.

4. The irrigation system of claim 3, wherein the first length of the at least one individual fluid conduit is between 38 feet and 45 feet.

5. The irrigation system of claim 3, wherein the plurality of fluid delivery conduits comprises at least one individual fluid conduit having a third length that is less than the first length and the second length.

6. The irrigation system of claim 1, wherein the uniform distance by which each of the plurality of receptacles is spaced apart is between 20″ and 60″ in length.

7. The irrigation system of claim 1, wherein the first end segment and the second end segment are between 2 and 3 feet in length.

8. The irrigation system of claim 1, wherein the elongated member comprises one or more of a post or a hook.

9. The irrigation system of claim 1, wherein the first profile shape is rectilinear.

10. The irrigation system of claim 1, wherein the first profile shape is circular.

11. The irrigation system of claim 1, wherein:
the second recess extends entirely through the bushing from a first opening on a first side of the bushing to a second opening on a second side of the bushing; and
the perimeter wall of the second recess comprises a first chamfer extending from the first opening and a second chamfer extending from the second opening and converging with the first chamfer.

12. The irrigation system of claim 1, wherein the elongated member is curved along a longitudinal axis.

13. An irrigation system comprising:
a first joint coupled to a second joint;
the first joint comprising a first terminal end and an elongated member coupled to the first terminal end, the elongated member comprising a first profile shape;
the second joint comprising a second terminal end and a receiver plate affixed to the second terminal end, the receiver plate comprising a first recess; and
a bushing positioned in the first recess, the bushing comprising a second recess, wherein:
the second recess includes a perimeter wall comprising a second profile shape;
the second profile shape corresponds to the first profile shape; and
the elongated member extends through the second recess.

14. The irrigation system of claim 13, wherein the elongated member comprises one or more of a post or a hook.

15. The irrigation system of claim 13, wherein the first profile shape is rectilinear.

16. The irrigation system of claim 13, wherein the first profile shape is circular.

17. The irrigation system of claim 13, wherein:
the second recess extends entirely through the bushing from a first opening on a first side of the bushing to a second opening on a second side of the bushing; and
the perimeter wall of the second recess comprises a first chamfer extending from the first opening and a second chamfer extending from the second opening and converging with the first chamfer.

18. A joint for an irrigation system, the pipe comprising:
a terminal end;
a receiver plate affixed to the terminal end;
the receiver plate comprising a first recess; and
a bushing positioned in the first recess, the bushing comprising a second recess extending entirely through the bushing from a first opening on a first side of the bushing to a second opening on a second side of the bushing, wherein:
the second recess includes a perimeter wall; and
the perimeter wall of the second recess comprises a first chamfer extending from the first opening and a second chamfer extending from the second opening and converging with the first chamfer at a waist that is narrower than the first opening and the second opening.

19. The joint of claim 18, wherein, at the waist, the second recess comprises a profile shape that is circular.

20. The joint of claim 18, wherein, at the waist, the second recess comprises a profile shape that is rectangular.
